(19) United States
(12) Patent Application Publication
(10) Pub. No.: US 2008/0193121 A1
(43) Pub. Date: Aug. 14, 2008

(54) IMAGING APPARATUS

(75) Inventor: Takao Miyazaki, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/027,688

(22) Filed: Feb. 7, 2008

(30) Foreign Application Priority Data
Feb. 8, 2007 (JP) 2007-029238

(51) Int. Cl. G03B 17/00

(52) U.S. Cl. 396/299

(57) ABSTRACT

An operation member cover is attached to a rear surface of a digital camera through a pair of grooves, and an upper end (up button portion) and a lower end (down button portion) of a cross key are exposed from openings of the operation member cover. Inside the groove, an attachment detection sensor is provided to detect attachment of the operation member cover. When the operation member cover is detected, a controller of the digital camera sets inaccessible photographic conditions to preset conditions for entry level users. Also, the controller gets the up and down button portions, exposed from the openings, to function as a flash photography setting button and a self-photography setting button. The digital camera now becomes a simplified, easy-to-use camera.

### FIELD OF THE INVENTION

The present invention relates to an imaging apparatus having an image sensor to convert a captured image into electric signals.

### BACKGROUND OF THE INVENTION

Digital cameras are widely prevalent as an imaging device. Equipped with an image sensor such as CCD or CMOS, the digital camera converts the image signal, coming out of the image sensor, into digital image data and then stores the data in a recording medium such as a memory card.

The current digital cameras are becoming more and more sophisticated, and require various operations and settings for a variety of functions. The functions are, for example, selection of a still image capture mode/movie capture mode/image reproduction mode (camera mode setting), a zooming operation to change the focal length of a zoom lens, selection of exposure metering method for auto-exposure control, selection of focusing method for auto-focus adjustment, flash mode setting, setting of self-photography mode and self-timer adjustment, auto/manual selection for white balance, ISO sensitivity setting, image size setting, and image quality setting. These operations and settings for photography (hereinafter, photographic condition settings) are somewhat difficult to entry-level users, who may possibly perform erroneous operation and make photography under an unintended photographic condition.

In view of this, several imaging apparatus are designed for simple operation. For example, an imaging apparatus disclosed in Japanese Patent Laid-open Publication No. 2006-60614 includes a function setting unit that remotely controls the imaging apparatus main body. This function setting unit transmits a predetermined set of function parameters to the imaging apparatus main body, and eliminates the need to set each parameter individually. Also, an imaging apparatus disclosed in Japanese Patent Laid-open Publication No. 2004-186798 moves a cursor cyclically to each item on various setting screens at certain time intervals, and enables various settings with a single input means. Further, an imaging apparatus disclosed in Japanese Patent Laid-open Publication No. 2005-117519 includes a separate operation member for frequently-used functions and high use-value functions.

However, since they are all designed for simple setting operations, not for preventing incorrect settings, these imaging apparatus are still difficult for the entry-level users to use. The possibility still remains that the entry-level users make photography under incorrect settings. Therefore, in most cases, this type of multi-functional imaging apparatus is used exclusively by the experienced users.

### SUMMARY OF THE INVENTION

In view of the foregoing, a main object of the present invention is to provide an imaging apparatus which even entry-level users can easily use.

Another object of the present invention is to provide an imaging apparatus capable of preventing incorrect settings of photographic conditions.

In order to achieve the above and other objects, an imaging apparatus according to the present invention includes a plurality of operation members, an operation member cover for covering a part of these operation members, an attachment portion to receive the operation member cover, an attachment detector for detecting attachment of the operation member cover, and a controller. This imaging apparatus captures a subject image under the photographic conditions established with the operation members, and generates image data. When attachment of the operation member cover is detected, the controller sets inaccessible photographic conditions, because of the presence of the operation member cover, to preset conditions.

It is preferred to provide the imaging apparatus with a selector for selecting between a first mode and a second mode. When attachment of the operation member cover is detected, the inaccessible photographic conditions are set to the preset conditions in the first mode, while they are maintained to the current settings in the second mode.

It is also preferred that the controller disables the functions of the operation members covered with the operation member cover.

Preferably, the operation member cover has at least one opening to expose a part of the operation members. When attachment of the operation member cover is detected, the controller preferably changes the functions of the operation members exposed from the opening.

The attachment portion is preferably a pair of substantially parallel grooves on a surface of the apparatus main body. In this case, the operation member cover is further provided with an engaging portion that releasably engages with the grooves, and the attachment detector is located in one of the grooves.

It is preferred to provide a display for displaying a reproduced image of the image data. In this case, the controller displays on the display that the operation member cover is attached.

It is also preferred to provide a power switch to turn on and off electric power and a clock unit which keeps time independent of operation of the power switch and generates time and date information.

When electric power is turned off with the operation member cover being attached, the controller preferably displays the time and date information on the display, and changes the functions of the uncovered operation members such that the time and date information can be corrected. It is possible to provide a time and date display device to display the time and date information.

According to the present invention, the photographic conditions are set to the preset conditions (the photographic conditions for entry level users) when the operation member cover is attached to the imaging apparatus. Even the entry-level users can therefore avoid making incorrect settings, and can use the imaging apparatus without trouble.

When the operation member cover is attached, the inaccessible photographic conditions are set to the preset conditions in the first mode. In the second mode, on the other hand, the inaccessible photographic conditions are maintained to the current (i.e., previous) settings. Since the current photographic conditions can be locked during photography in the second mode, the experienced users, as well as the entry-level users, can make full use of the imaging apparatus. Moreover, since the once established photographic conditions are protected from erroneous changes, an experienced user will attach the operation member cover to his or her imaging apparatus and easily lend it to an entry-level user.

### BRIEF DESCRIPTION OF THE DRAWINGS

The above objects and advantages of the present invention will become more apparent from the following detailed description when read in connection with the accompanying drawings, in which:

FIG. 1 is a front perspective view of a digital camera according to the present invention;

FIG. 2 is a rear perspective view of the digital camera;

FIG. 3 is a rear perspective view of the digital camera with an operation member cover being attached;

FIG. 4 is a block diagram showing an electrical configuration of the digital camera;

FIG. 5 is a flow chart of a photographic condition setting procedure;

FIG. 6 is a display surface of an LCD displaying a menu screen;

FIG. 7 is the display surface displaying an image for framing;

FIG. 8 is the display surface displaying time and date information;

FIG. 9 is the display surface displaying a menu screen according to a second embodiment of the present invention; and

FIG. 10 is a flow chart of a photographic condition setting procedure according to the second embodiment.

### DETAILED DESCRIPTION OF THE PREFERRED EMBODIMENTS

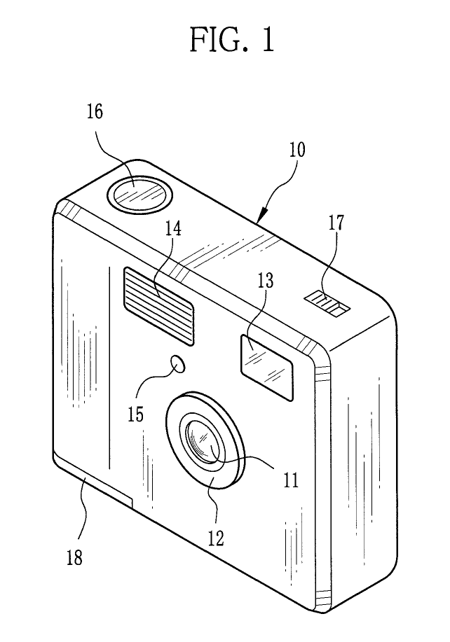

Referring to FIG. 1, a digital camera 10 has a lens barrel 12 holding a taking lens 11, a view finder window 13, a flash emitter 14, and a light emitting diode (LED) 15 on a front surface thereof. On a top surface of the digital camera 10, a shutter button 16 and a power switch 17 are provided. On a bottom surface of the digital camera 10, a cover 18 for a battery/memory card retainer is attached.

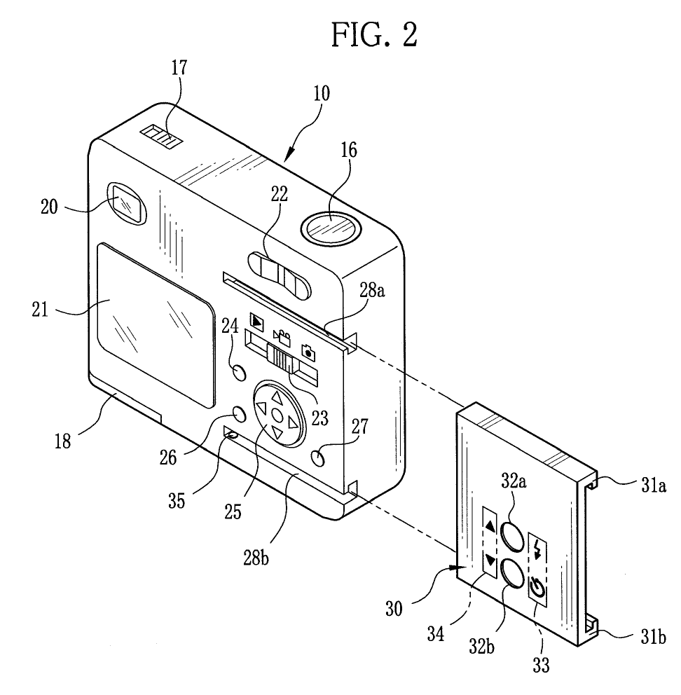

As shown in FIG. 2, a rear surface of the digital camera 10 is provided with an optical viewfinder 20, a liquid crystal display (LCD) 21, and operation members including a zoom switch 22, a mode selector switch 23, a menu button 24, a cross key (multi-function key) 25, a display button 26 and a delete button 27. The optical viewfinder 20 and the LCD 21 are located on the left side of the rear surface, and the operation members are located on the right side thereof. This locating, however, can be reversed.

The optical viewfinder 20 is a window through which a photographic subject (hereinafter, photo-subject) is observed. The LCD 21 displays a preview of a captured image or a reproduction of the image stored in a memory card, and also functions as an electronic view finder to display a through image for photography. Additionally, the LCD 21 displays menu screens to allow various settings of the digital camera 10.

The zoom switch 22 is a seesaw switch to be pressed down on one end in the horizontal direction. Pressing on the right end of the zoom switch 22 allows zooming in the distant (TELE) direction, while pressing on the left end thereof allows zooming in the wide angle (WIDE) direction. The mode selector switch 23 is a slide switch that slides right and left to change the operation modes of the digital camera 10. The mode selector switch 23 is moved to one of three positions of right, center and left, which correspond to a still image capture mode, a movie capture mode and an image reproduction mode respectively.

The menu button 24 is a push button switch that leads the LCD 21 to display the menu screen. The cross key 25, when pressed on one of the horizontal and vertical ends, enters the command corresponding to the pressed end. The cross key 25 allows selection of a setting item, change of the settings, forward/reverse feed of the reproduction image frames, and other operations. Provided in the center of the cross key 25 is a push button switch to determine the selected item on the menu screen.

The menu screen allows various settings, such as ISO sensitivity (auto/manual setting), AE (settings of exposure metering method/exposure correction value), WB (auto/manual scene setting), AF (AF area), picture size (settings of number of pixels/aspect ratio), image quality (compression rate setting), flash mode (auto: automatic low brightness emission/on: forced emission/off: no emission), self-timer (on/off) and the like.

The display button 26 is a push button switch that activates and inactivates the LCD 21. Even when the LCD 21 is inactivated, however, photography can be made using the optical viewfinder 20. The delete button 27 is also a push button switch to delete a stored image from a memory card or the like.

A pair of thin, substantially parallel grooves 28a, 28b is formed on the rear surface of the digital camera 10, and the operation members except the zoom switch 22 are located between these grooves 28a, 28b. The zoom switch 22 is located above the groove 28a.

An operation member cover 30 is attached to the grooves 28a, 28b, and covers the operation members between grooves 28a, 28b. Each of the grooves 28a, 28b extends from the right side edge to almost the center of the rear surface of the digital camera 10, and has a substantially L-shaped cross section. The operation member cover 30, on the other hand, is a substantially flat plate with engaging portions 31a, 31b formed along the upper and the lower sides. These engaging portions 31a, 31b have also a substantially L-shaped cross section, and slide-engage with the grooves 28a, 28b.

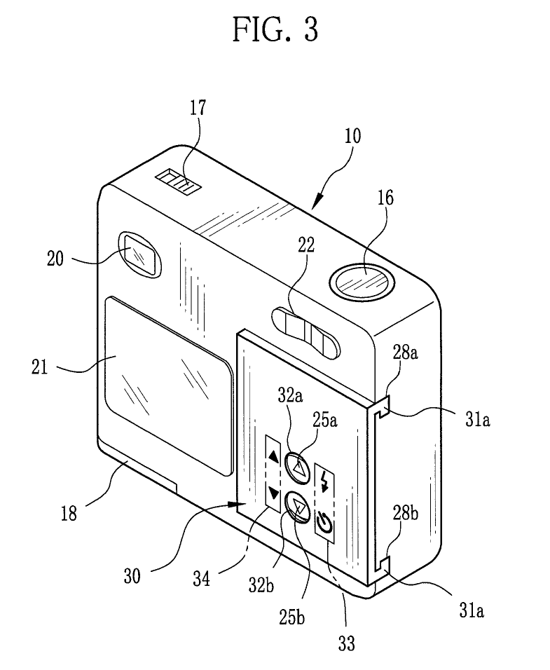

The operation member cover 30 has circular openings 32a, 32b. When the operation member cover 30 is attached to the rear surface of the digital camera 10, as shown in FIG. 3, an upper end (up button portion) 25a and an lower end (down button portion) 25b of the cross key 25 are exposed from the openings 32a, 32b respectively. In this instance, only the zoom switch 22 and the up and down button portions 25a, 25b of the cross key 25 are operable among the operation members.

Additionally, marks 33, 34 are printed by silkscreen on the operation member cover 30. The mark 33 is on the right side of the openings 32a, 32b, and indicates the functions of the up and the down button portions 25a, 25b (flash photography setting and self photography setting) in the power-on state. On the other hand, the mark 34 is on the left side of the openings 32a, 32b, and indicates the functions of the up and the down button portions 25a, 25b (cursor move on the LCD 21) in the power-off state.

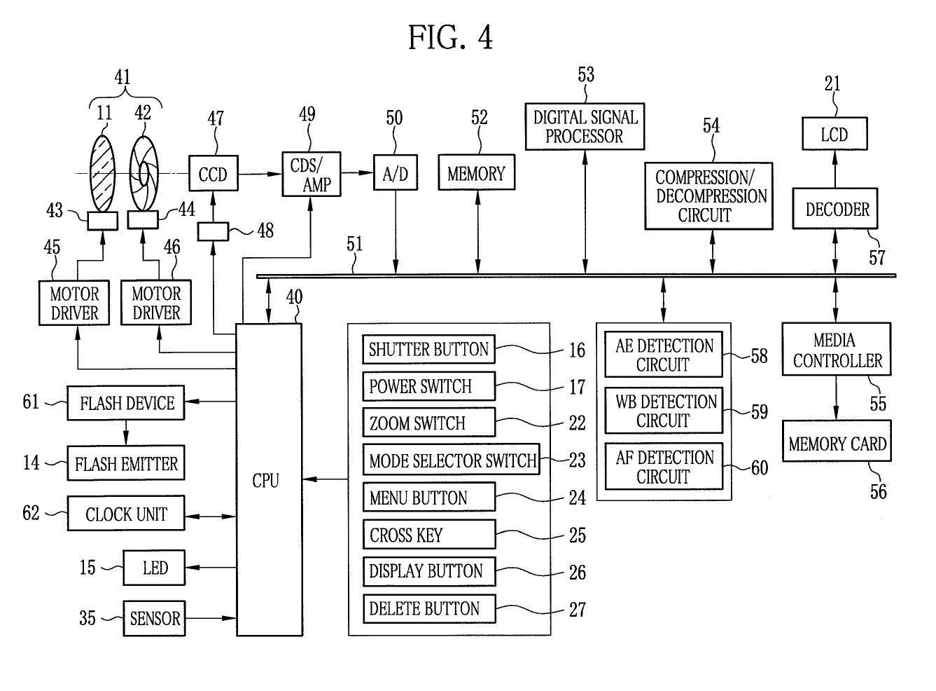

On the distal end of the groove 28b, as better shown in FIG. 2, an attachment detection sensor 35 is provided to detect the attachment of the operation member cover 30. The attachment detection sensor 35 is a contact type sensor that senses contact to the operation member cover 30 and sends a detection signal to a CPU 40 (see, FIG. 4) when the operation member cover 30 is attached to the digital camera 10. When receiving the detection signal, the CPU 40 disables the functions of the covered operation members (the mode selector switch 23, the menu button 24, the cross key 25 except the upper and lower end portions 25a, 25b, the display button 26 and the delete button 27), and changes the functions of the upper and lower end portions 25a, 25b exposed from the openings 32a, 32b of the operation member cover 30.

In FIG. 4, the CPU (controller) 40 controls each component of the digital camera 10 in response to various operation signals from the operation members.

An optical system 41 is composed of the taking lens 11 and an aperture stop 42. The taking lens 11 includes a focusing lens and a varifocal lens, and these lenses are driven by a lens driver mechanism 43. The aperture stop 42 is driven by an aperture stop driver mechanism 44. Driven by motor drivers 45, 46 under the control of the CPU 40, the lens driver mechanism 43 and the aperture stop driver mechanism 44 carry out focusing and zooming, and also change the aperture value.

Located behind the optical system 41 is a CCD image sensor (hereinafter, CCD) 47. Driven by a CCD driver system 48, the CCD 47 photo-electrically converts photo-subject light having passed through the optical system 41, and generates an image signal. This image signal, out of the CCD 47, is transmitted to a CDS/AMP circuit 49. The CCD 47 is a single plate type color image sensor, of which the pixels are combined with a color filter having a predetermined spectral characteristics (for example, an RGB primary color filter), and the image signal is the pixel signal that corresponds to each pixel color.

The CDS/AMP circuit 49 applies a correlation double sampling (CDS) process to the image signal so as to remove amp noises and reset noises of the CCD 47, and then amplifies this cleaned image signal. The signal amplification factor at this stage is determined according to the ISO sensitivity value.

The image signal out of the CDS/AMP circuit 49 is converted by an A/D converter 50 into a digital signal (image data) of a predetermined gradation value, and temporarily stored in a memory 52, such as an SDRAM, through a data bus 51. The image data retrieved from the memory 52 is transmitted through the data bus 51 to a digital signal processor 53 and processed.

The digital signal processor 53 applies various processing such as, for example, a WB (white balance) processing, a gamma correction processing, a synchronization processing, a luminous and color difference (YC) conversion processing, and a pixel skipping processing, to the image data. The image data is thus converted into YC image data and stored in the memory 52. In the still image capture mode, this YC image data is compressed under the JPEG format or the like by a compression/decompression circuit 54, and stored in a memory card 56 through a media controller 55. Note that the digital signal processor 53 skips the pixels of image data according to the image size specified by the user, and the compression/decompression circuit 54 changes the compression ratio according to the image quality specified by the user.

In the image reproduction mode, the media controller 55 retrieves the image data from the memory card 56. The retrieved data is decompressed in the compression/decompression circuit 54, and the decompressed image data is displayed on the LCD 21 through a decoder 57.

In the movie capture mode, on the other hand, the CCD 47 performs pixel skip reading or pixel addition to generate a series of field image data, which is then stored sequentially in the memory 52. The image data for each field is processed in the digital signal processor 53. The processed image data is compressed under the MPEG format or the like by the compression/decompression circuit 54, and stored as movie data in the memory card 56 through the media controller 55. In the image reproduction mode, the movie data in the memory 52 is decompressed by the compression/decompression circuit 54, and displayed on the LCD 21 through the decoder 57.

Three detection circuits of an AE detection circuit 58, a WB detection circuit 59 and an AF detection circuit 60 calculate the evaluated values necessary for auto exposure (AE), white balance (WB) and auto focusing (AF).

According to the exposure metering method selected by the user, the AE detection circuit 58 changes the area to be measured on a displayed image. When a multi-divided metering is selected, the AE detection circuit 58 divides the displayed image into plural areas and calculates the integral of the pixel luminance signals for each divided area, and then transmits each integral value (AE evaluated values) to the CPU 40. Based on the AE evaluated values, the CPU 40 calculates the brightness of a photo-subject, and calculates an appropriate exposure value (EV value) for photography. Additionally, based on a given program chart and the EV value calculated, the CPU 40 determines an aperture stop value and a shutter speed, and then drives the motor driver 46 and the CCD driver system 48. When a spot metering is selected, on the other hand, the AE evaluated values are calculated from the luminance signals of the limited areas in the displayed image.

According to the exposure correction value specified by the user, the CPU 40 adjusts exposure on the basis of the optimum exposure value. Also, the CPU 40 determines the appropriate exposure value and the ISO sensitivity when the user selects “auto” for the ISO sensitivity setting.

The WB detection circuit 59 divides the displayed image into plural areas, and calculates the averaged values of the R, G and B signals for each divided area, and then transmits these averaged values to the CPU 40. When “auto” is selected for the white balance (WB) setting, the CPU 40 calculates an R/G ratio and a B/G ratio based on the R, G and B values obtained by the WB detection circuit 59, and discriminates the scene (type of the light source) based on these color ratios and the information about the exposure value obtained in the AE calculation. Then, according to a predetermined WB adjusting value appropriate to the discriminated scene, the CPU 40 adjusts the gain of a WB processor in the digital signal processor 53 such that each color ratio becomes 1 (the integral ratio R:G:B becomes substantially 1:1:1 in a single displayed image). When the user manually specifies the scene, on the other hand, the white balance is adjusted based on the specified scene.

The AF detection circuit 60 extracts high-frequency components of the luminance signals or the G signals from a designated area (AF area) in the display surface, and transmits the integral of the absolute values of these high-frequency components (AF integral value) to the CPU 40. The AF detection circuit 60 calculates and transmits the AF integral value to the CPU 40 every time the image data is updated in the memory 52. The CPU 40 determines the position of the focusing lens so as to maximize the AF integral value (i.e., so as to maximize the contrast). The AF area can be changed by the user. The AF detection circuit 60 extracts high-frequency components from the AF area specified by the user.

When the “on” (forced emission) mode is selected, the CPU 40 drives the flash device 61 to flash the flash emitter 14 in response to the pressing of the shutter button 16 in the still image capture mode. When the “auto” mode is selected, on the other hand, the CPU 40 flashes the flash emitter 14 only when the brightness of a photo-subject is detected lower than a predetermined level during the AE operation.

A clock unit 62, in the still image capture mode, starts measuring time immediately after the pressing of the shutter release button if the self-photography is enabled. The CPU 40 blinks the LED 15 to inform the user of running of the self-timer, and captures a still image after a predetermined duration of time (for example, 10 seconds) based on the elapsed-time information from the clock unit 62.

Also, the clock unit 62 continuously keeps time and date, and sends the time and date information to the CPU 40. This time keeping operation is independent of operation of the power switch 17, and therefore performed even in the power-off state. In the power-on state, the CPU 40 displays the time and date information on the LCD 21, and also adds the time and date information to the image data to be stored in the memory card 56. The time and date information is kept displayed on the LCD 21 even in the power-off state.

When it touches the engaging portion 31b of the operation member cover 30, the attachment detection sensor 35 transmits a detection signal to the CPU 40. Upon receiving the detection signal, the CPU 40 disables the functions of the operation members covered with the operation member cover 30. The photographic conditions therefore become inaccessible from these operation members. Subsequently, the CPU 40 sets the inaccessible photographic conditions (operation mode, ISO sensitivity, AE/WB/AF, picture size, image quality and so forth) to predetermined conditions (preset conditions) regardless of the current photographic conditions. These preset conditions are for entry-level users (for example, operation mode: still image capture mode, ISO sensitivity: auto, AE method: multi-divided metering, exposure correction: ±0, WB: auto, AF area: center, picture size: full, image quality: fine).

Additionally, when the operation member cover 30 is attached, the CPU 40 displays on the LCD 21 a message that the photographic conditions not for entry level users are locked (i.e., protected from changes). The CPU 40 also changes the functions of the up and down button portions 25a, 25b which are exposed from the openings of the operation member cover 30. In the power-on state, as indicated by the mark 33, the up button portion 25a functions as a flash photography setting button, and the down button 25b functions as a self-photography setting button. In the power-off state, as indicated by the mark 34, the up and down button portions 25a, 25b function as up and down shift buttons for a cursor on the LCD 21, and the zoom switch 22 is changed to a right and left shift button. It is to be noted that the clock unit 62 is connected to an additional power supply independent of the power switch 17. Accordingly, in the power-off state, only the time keeping function continues to run, while the photography function and the image reproduction function are completely stopped.

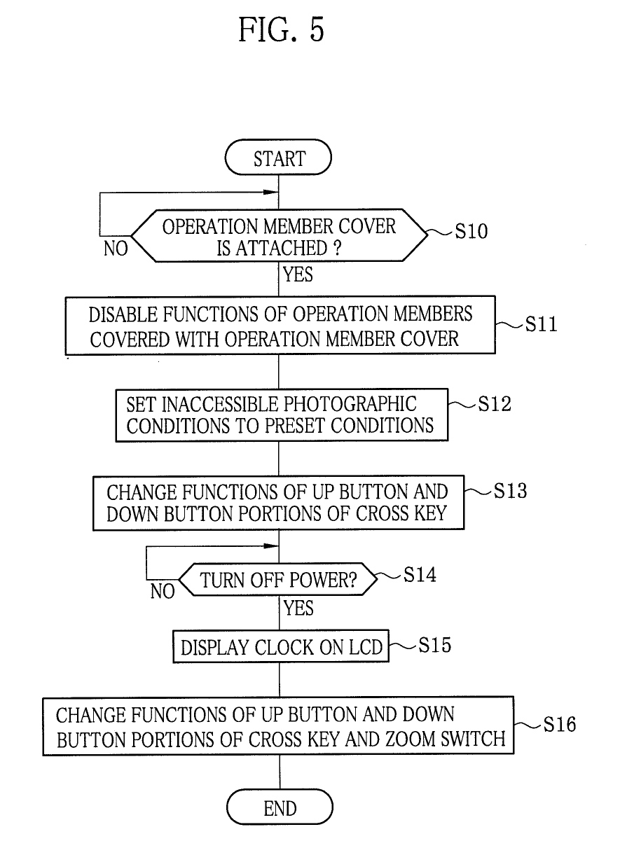

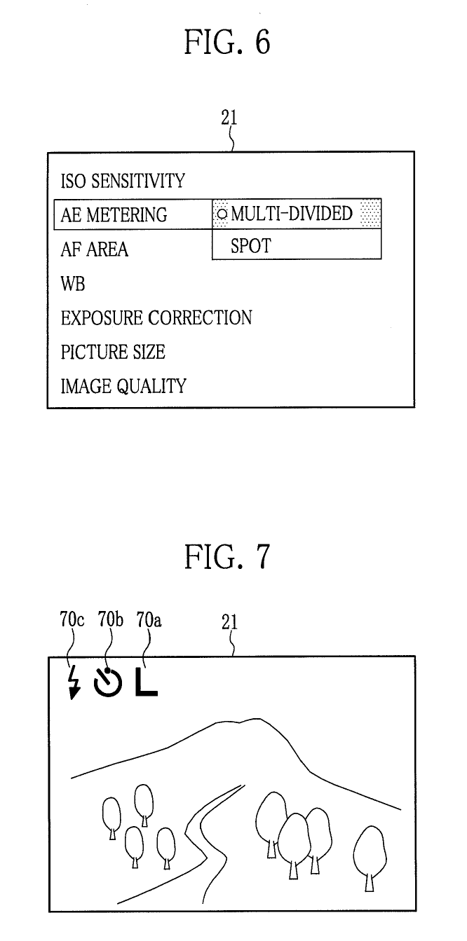

Next, with reference to a flowchart of FIG. 5, the operation of the digital camera 10 is described. In the power-on state, if the operation member cover 30 is not attached to the grooves 28a, 28b (“NO” in step S10), the photographic conditions can be established (or changed) with the menu button 24 and the cross key 25. When the menu button 24 is pressed, the menu screen for the photographic conditions, such as shown in FIG. 6, appears on the LCD 21. In this state, the user can set an intended photographic condition by operating the cross key 25. While the operation member cover 30 is not attached, one of the still image capture mode, the movie capture mode and the image reproduction mode can be selected with the mode selector switch 23.

When the operation member cover 30 is attached to the grooves 28a, 28b as shown in FIG. 3, the attachment detection sensor 35 detects the operation member cover 30 (“YES” in step S10). The CPU 40 disables the functions of the covered operation members, which are the mode selector switch 23, the menu button 24, the cross key 25 except the up and down button portions 25a, 25b, the display button 26, and the delete button 27 (step S11). Consequently, the inaccessible photographic conditions (operation mode, ISO sensitivity, AE/WB/AF, picture size, image quality and so forth) are set to the preset conditions regardless of the current photographic conditions (step S12). Also, the functions of the up and down button portions 25a, 25b, exposed from the openings 32a, 32b of the operation member cover 30, are changed so that the up button portion 25a and the down button portion 25b will function as the flash setting button and the self-timer setting button respectively (step S13).

The digital camera 10 is now functioning as a simplified, easy-to-use camera which only allows for users to make the flash photography setting, the self-photography setting, the zooming operation and the shutter button operation. The through image on the LCD 21 in this state is shown in FIG. 7, and a mark 70a appears in the upper left area of the screen to indicate that the operation member cover 30 is attached (thus, the photographic conditions not for the entry-level users are locked). Next to the mark 70a, a mark 70b appears to indicate the self-photography setting, and next to the mark 70b, a mark 70c appears to indicate the flash photography setting.

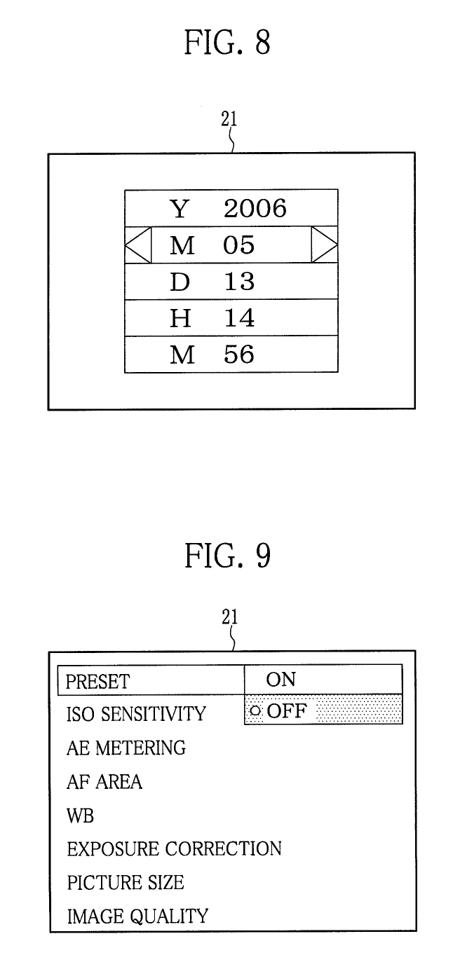

When electric power is turned off (“YES” in step S14), the time and data information as sown in FIG. 8 is displayed on the LCD 21 (step S15). At the same instance, the functions of the up and the down button portions 25a, 25b and the zoom switch 22 are changed to the up, down, right and left shift buttons (step S16). The date on the LCD 21 can be corrected by operating the up and down button portions 25a, 25b to select a Year (Y), Month (M), Date (D), Hour (H) and Minute (M), and by operating the zoom switch 22 to increase or decrease the digit.

As just described, when the operation member cover 30 is attached, the digital camera 10 locks the photographic conditions not for entry-level users. These photographic conditions are then set to the preset conditions, and the digital camera 10 converts into a simplified, easily-handled camera for entry level users. The preset conditions are cancelled when the operation member cover 30 is detached, and the photographic conditions can be changed with the operation members.

Now, a digital camera according to the second embodiment of the present invention is described. The second embodiment camera has the same configuration as the digital camera 10 of the first embodiment, but only differs in the function of the CPU 40. The second embodiment camera allows the users to choose whether to use the preset conditions (a first mode) or maintain the current conditions (a second mode) for the inaccessible photographic conditions when the operation member cover 30 is attached. The first mode is chosen by selecting “ON” in an item “PRESET” on the menu screen, and the second mode is chosen by selecting “OFF” in the item “PRESET”. The CPU 40 establishes the photographic conditions according to the mode chosen.

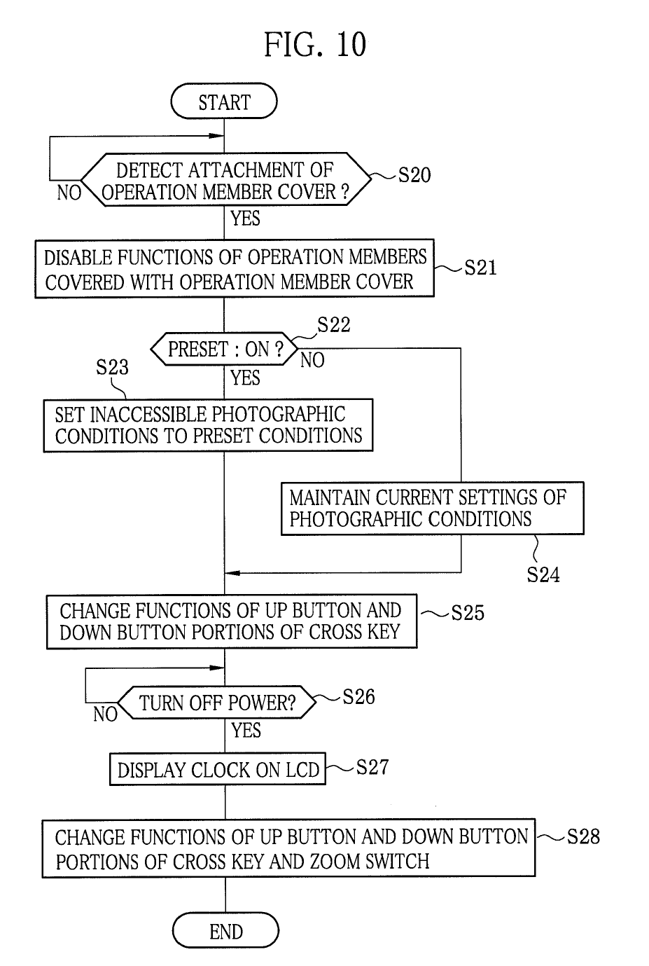

Next, with reference to the flow chart in FIG. 10, the operation of the second embodiment is described. In the power-on state, if the operation member cover 30 is not attached to the grooves 28a, 28b (“NO” in step S20), the photographic conditions can be established (or changed) with the menu button 24 and the cross key 25. When the menu button 24 is pressed, the menu screen for the photographic conditions, such as shown in FIG. 9, appears on the LCD 21. In this state, the user can establish an intended photographic condition by operating the cross key 25. Also, the user can select the first mode or the second mode by operating the cross key 25.

When the operation member cover 30 is attached to the grooves 28a, 28b, the attachment detection sensor 35 detects attachment (“YES” in step S20). The CPU 40 disables the functions of the covered operation members, which are the mode selector switch 23, the menu button 24, the cross key 25 except the up and down button portions 25a, 25b, the display button 26, and the delete button 27 (step S21). Also, whether the item “PRESET” on the menu screen is “ON” (the first mode) or “OFF” (the second mode) is identified (step S22). If the “PRESET” is “ON”, the inaccessible photographic conditions are set to the preset conditions (step S23), and if the “PRESET” is “OFF”, the photographic conditions just before attachment of the operation member cover 30 are maintained (step S24).

Subsequent steps S25 to S28 are identical to the steps S14 to S16, and the explanation thereof is omitted. The photographic conditions in the step S24 are maintained, even after the power is off, so long as the operation member cover 30 is attached. When the operation member cover 30 is detached, all the operation members become operable.

As just described, the digital camera according to the second embodiment maintains the current photographic conditions when the operation member cover 30 is attached, and is able to meet the need of the experienced users as well as of the entry level users. Since this digital camera is also able to prevent the erroneous changes to the once established photographic conditions, an experienced user will attach the operation member cover 30 to his or her digital camera and easily lend it to an entry level user. Additionally, the present invention is suitable for rental cameras. In this case, the operation member cover 30 is attached to the camera if the renter is an entry-level user, and the operation member cover 30 is detached if the renter is an experienced user.

The present invention is not limited to the above embodiments, but various changes can be made instead. For example, while the operation member cover comes apart from the digital camera in the above embodiments, it maybe connected to the digital camera with a cord or the like. Additionally, the operation member cover is not limited to a slide type cover as in the above embodiments, but may be an open/close type cover (either swing open or slide open) on the digital camera. In this case, the closed state of the open/close cover corresponds to the attached state of the slide cover. Furthermore, the operation members to be covered and to be exposed from the opening of the operation member cover are not limited to the above embodiments, but may be determined as needed.

The present invention is not only applicable to the digital cameras, but also to camera phones, camcorder, and such devices.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An imaging apparatus to capture an image of a subject: under established photographic conditions and produce image data, comprising:
a plurality of operation members for establishing said photographic conditions;
an operation member cover for covering a part of said operation members;
an attachment portion to which said operation member cover is attached;
an attachment detector for detecting attachment of said operation member cover; and
a controller for setting inaccessible photographic conditions among said photographic conditions because of said operation member cover to preset conditions when attachment of said operation member cover is detected.

2. The imaging apparatus of claim 1, further comprising:
a selector for selecting between a first mode and a second mode,
wherein when attachment of said operation member cover is detected in said first mode, said controller sets said inaccessible photographic conditions to said preset conditions, and in said second mode said controller maintains the current settings of said inaccessible photographic conditions.

3. The imaging apparatus of claim 1, wherein said controller disables the functions of the operation members covered with said operation member cover.

4. The imaging apparatus of claim 1, wherein said operation member cover has at least one opening to expose a part of said operation members, and said controller changes the functions of the operation members exposed from said opening when attachment of said operation member cover is detected.

5. The imaging apparatus of claim 1, wherein said attachment portion is a pair of substantially parallel grooves on a surface of an apparatus main body, and said operation member cover has an engaging portion releasably engaging with said grooves, and said attachment detector is provided in one of said grooves.

6. The imaging apparatus of claim 1, further comprising:
a display for displaying a reproduced image of said image data,
wherein said controller displays on said display that said operation member cover is attached.

7. The imaging apparatus of claim 6, further comprising:
a power switch to turn on and off electric power; and
a clock unit for keeping time independent of operation of said power switch and generating time and date information.

8. The imaging apparatus of claim 7, wherein when said electric power is turned off with said operation member cover being attached, said controller displays said time and date information on said display and changes the functions of the operation members uncovered with said operation member cover, so as to allow correction to said time and date information.

9. The imaging apparatus of claim 7, further comprising a time and date display device to display said time and date information.
